(19) United States
(12) Patent Application Publication
(10) Pub. No.: US 2014/0123954 A1
(43) Pub. Date: May 8, 2014

(54) FUEL AMOUNT DISTRIBUTION METHOD FOR ENGINE WITH DUAL INJECTOR AND APPARATUS THEREFOR

(71) Applicant: HYUNDAI MOTOR COMPANY, Seoul (KR)

(72) Inventor: Hyung Ju Lee, Seoul (KR)

(73) Assignee: Hyundai Motor Company, Seoul (KR)

(21) Appl. No.: 13/722,645

(22) Filed: Dec. 20, 2012

(30) Foreign Application Priority Data
Nov. 5, 2012 (KR) 10-2012-0124051

(51) Int. Cl. F02M 69/00

(52) U.S. Cl. CPC F02M 69/00
USPC 123/478

(57) ABSTRACT

It is possible to improve volatility of fuel in a fuel-gas mixture and improve the combustion performance of an engine by appropriately distributing the amount of fuel that is injected from two injectors disposed in two intake port, in a dual injector engine.

### CROSS-REFERENCE TO RELATED APPLICATION

The present application claims priority of Korean Patent Application Number 10-2012-0124051 filed Nov. 5, 2012, the entire contents of which application is incorporated herein for all purposes by this reference.

### BACKGROUND OF INVENTION

1. Field of Invention

The present invention relates to a method of controlling a dual injector engine that supplies fuel to the same combustion chamber through two injectors, and more particularly, a method of distributing the amount of fuel to be injected by two injectors.

2. Description of Related Art

Engines of the related art are generally equipped with only one injector in the intake port and controlled to inject the whole fuel supplied to a corresponding combustion chamber by means of one injector.

On the other hand, in dual injector engines, in order to improve fuel efficiency by increasing a volume efficiency and to reduce toxic substances, as illustrated in FIG. 1, an injector 502 is disposed in each of two intake ports 500 that communicate with one combustion chamber and fuel can be appropriately supplied to the combustion chamber by controlling the two injectors 502.

Therefore, the fuel to be supplied to one combustion chamber is supplied to be injected through two separate injectors in the dual injector engines, but the two intake ports that communicate with one combustion chamber is difficult to have the completely same shape due to the relationships with other parts and are formed at essentially different positions, so that a change is generated in flow of air through the two intake ports and the mixing ratio of air and fuel is different even if the same amount of fuel is injected to the air flowing through the two intake ports, which may result in deterioration of volatility of the fuel in the entire system.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention has been made in an effort to solve the above-described problems associated with prior art. Various aspects of the present invention provide for a fuel amount distribution method for a dual injector engine which can improve volatility of fuel in a fuel-gas mixture and improve the combustion performance of an engine, by appropriately distributing the amount of fuel that is injected from two injectors disposed in two intake port, in a dual injector engine.

Various aspects of the present invention provide for a fuel amount distribution method for a dual injector engine including: a total amount-determining step for determining the total amount of fuel to be supplied to a combustion chamber; a first determining step for determining the first amount of fuel to be injected from a first injector supplying fuel to the combustion chamber; and a second determining step that determines the amount of fuel to be injected from a second injector supplying fuel to the combustion chamber by subtracting the first amount of fuel from the total amount of fuel determined by the total amount-determining step.

Various aspects of the present invention provide for fuel amount distribution method for a dual injector engine including: a total amount-determining step for determining the total amount of fuel to be supplied to a combustion chamber; and a ratio-applying step for determining a first amount of fuel to be injected from a first injector supplying fuel through a first port that communicates with the combustion chamber and a second amount of fuel to be injected from a second injector supplying fuel through a second port that communicates with the combustion chamber, in accordance with a predetermined injection ratio.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary part of an intake port of an engine equipped with a dual injector where the present invention is applied.

FIG. 2 is a flowchart illustrating an exemplary fuel amount distribution method for a dual injector engine according to the present invention.

FIG. 3 is a diagram illustrating an exemplary fuel amount distribution method for a dual injector engine according to the present invention.

FIG. 4 is a flowchart illustrating an exemplary fuel amount distribution method for a dual injector engine according to the present invention.

FIG. 5 is a diagram illustrating an exemplary fuel amount distribution apparatus for a dual injector engine according to the present invention.

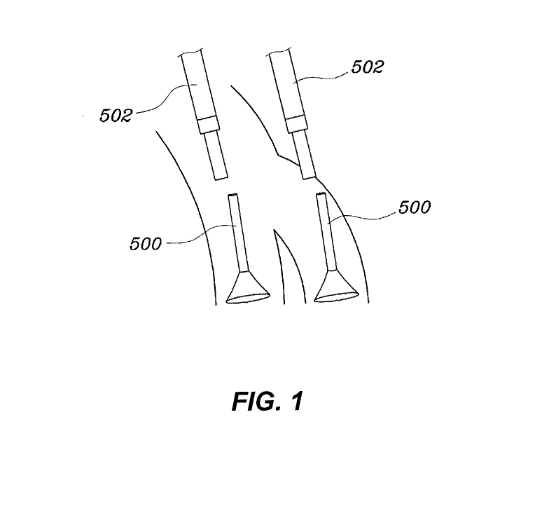

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

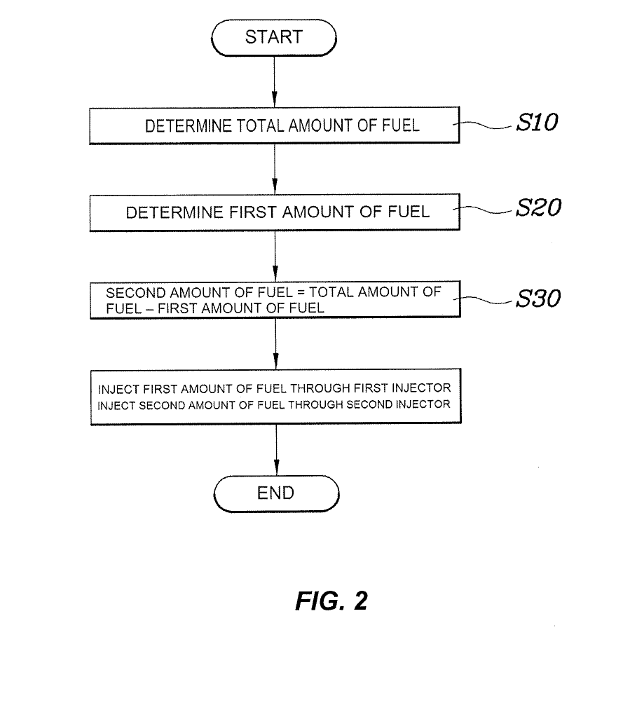

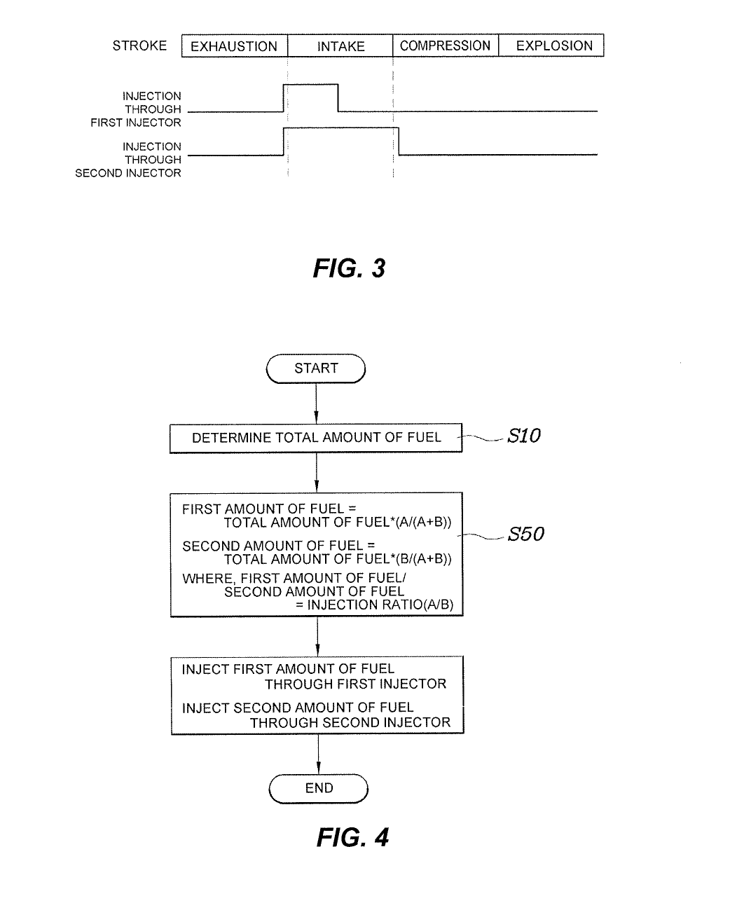

Referring to FIG. 2, a fuel amount distribution method for a dual injector engine according to the present invention includes: a total amount-determining step (S10) for determining the total amount of fuel to be supplied to a combustion chamber; a first determining step (S20) for determining the first amount of fuel to be injected from a first injector supplying fuel to the combustion chamber; and a second determining step (S30) for determining the amount of fuel to be injected from a second injector supplying fuel to the combustion chamber by subtracting the first amount of fuel from the total amount of fuel determined by the total amount-determining step (S10).

That is, according to the present invention, the total amount of fuel to be supplied to a corresponding combustion chamber is calculated by the total amount-determining step (S10) in accordance with the traveling status of a vehicle such as the operational amount of an acceleration pedal by a driver, the first amount of fuel to be injected from the first injector is determined, the second amount of fuel is determined by subtracting the first amount of fuel from the total amount of fuel, and then the fuel is injected through the first injector and the second injector, so that the total amount of fuel calculated by the total amount-determining step (S10) can be supplied to the combustion chamber.

In the first determining step (S20), the first amount of fuel may be determined such that volatility of the fuel-gas mixture that has passed through a first port and a second port becomes the same level by comparing the shape of the first port through which the fuel injected from the first injector passes with the shape of the second port through which the fuel injected from the second injector passes.

That is, consequently, the second amount of fuel is determined by determining the first amount of fuel such that the fuel volatility of the gas mixture that has passed through the first port and the second port can be maintained at the same level, in consideration of the flow of the gas mixture passing through the first port and the second port.

As described above, since the shapes and the relative positions of the first port and the second ports are different in most cases, the first amount of fuel determined in the first determining step (S20) and the second amount of fuel determined in the second determining step (S30) may be different values in most cases, as illustrated in FIG. 2.

As a result, as the first amount of fuel and the second amount of fuel are determined, as described above, and the fuel is distributed to the first injector and the second injector and then injected, the fuel volatility of the gas mixtures flowing inside through two path is maintained at the same level in the combustion chamber, so that the maximum fuel volatility is achieved, and consequently, combustion performance of the engine is improved.

Referring to FIG. 4, a fuel amount distribution method for a dual injector engine according to various embodiments of the present invention includes: a total amount-determining step (S10) for determining the total amount of fuel to be supplied to a combustion chamber; and a ratio-applying step (S50) for determining a first amount of fuel to be injected from a first injector supplying fuel through a first port that communicates with the combustion chamber and a second amount of fuel to be injected from a second injector supplying fuel through a second port that communicates with the combustion chamber, in accordance with a predetermined injection ratio.

That is, the total amount of fuel to be injected to a corresponding combustion chamber is determined on the basis of the operational amount of an acceleration pedal by a driver in the total amount-determining step (S10), the first amount of fuel and the second amount of fuel are determined by applying the injection ratio determined on the basis of the status of the two intake ports that communicates with the corresponding combustion chamber in advance in the ratio-applying step (S50), and the fuels are injected through the first injector and the second injector, respectively.

Obviously, the predetermined injection ratio applied to the first amount of fuel and the second amount of fuel in the ratio-applying step (S50) is set such that the volatility of the fuel-air mixture that has passed through the first port and the second port becomes the same level, in consideration of the shapes of the first port and the second port.

Similarly, the combustion performance of an engine may be consequently improved as much as possible by allowing the fuel volatility of the gas mixture finally supplied to the combustion chamber through the first port and the second port to be the same level in both intake flows such that the gas mixture with the highest fuel volatility can be burned under given conditions.

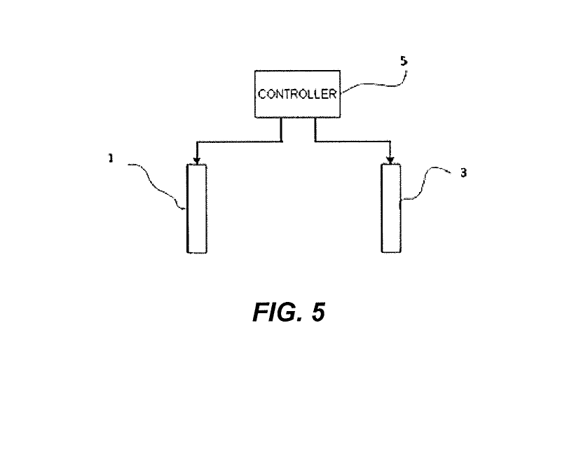

On the other hand, as illustrated in FIG. 5, it is possible to implement a fuel amount distribution apparatus for a dual injector engine including a controller 5 that determines the amount of fuel to inject to the first injector 1 and the second injector 3, in accordance with the fuel amount distribution method for a dual injector engine described above, and it is possible to implement a vehicle equipped with the fuel amount distribution apparatus.

According to the present invention, it is possible to improve volatility of fuel in a fuel-gas mixture and improve the combustion performance of an engine, by appropriately distributing the amount of fuel that is injected from two injectors disposed in two intake port, in a dual injector engine.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel amount distribution method for a dual injector engine, comprising:
a total amount-determining step for determining the total amount of fuel to be supplied to a combustion chamber;
a first determining step for determining the first amount of fuel to be injected from a first injector supplying fuel to the combustion chamber; and
a second determining step for determining the amount of fuel to be injected from a second injector supplying fuel to the combustion chamber by subtracting the first amount of fuel from the total amount of fuel determined by the total amount-determining step.

2. The method of claim 1, wherein the first amount of fuel determined in the first determining step and the second amount of fuel determined in the second determining step are different.

3. The method of claim 1, wherein the first amount of fuel is determined such that volatility of the fuel-gas mixture that has passed through a first port and a second port becomes the same level by comparing the shape of the first port through which the fuel injected from the first injector passes with the shape of the second port through which the fuel injected from the second injector passes.

4. A fuel amount distribution apparatus for a dual injector engine including a controller that determines the amount of fuel to inject to the first injector and the second injector, in accordance with the fuel amount distribution method for a dual injector engine according to clam 1.

5. A vehicle equipped with a fuel amount distribution apparatus for a dual injector engine including a controller that determines the amount of fuel to inject to the first injector and the second injector, in accordance with the fuel amount distribution method for a dual injector engine according to clam 1.

6. A fuel amount distribution method for a dual injector engine, comprising:
a total amount-determining step for determining the total amount of fuel to be supplied to a combustion chamber; and
a ratio-applying step for determining a first amount of fuel to be injected from a first injector supplying fuel through a first port that communicates with the combustion chamber and a second amount of fuel to be injected from a second injector supplying fuel through a second port that communicates with the combustion chamber, in accordance with a predetermined injection ratio.

7. The method of claim 6, wherein the predetermined injection ratio applied to the first amount of fuel and the second amount of fuel in the ratio-applying step is set such that the volatility of the fuel-air mixture that has passed through the first port and the second port becomes the same level, in consideration of the shapes of the first port and the second port.

8. A fuel amount distribution apparatus for a dual injector engine including a controller that determines the amount of fuel to inject to the first injector and the second injector, in accordance with the fuel amount distribution method for a dual injector engine according to clam 6.

9. A vehicle equipped with a fuel amount distribution apparatus for a dual injector engine including a controller that determines the amount of fuel to inject to the first injector and the second injector, in accordance with the fuel amount distribution method for a dual injector engine according to clam 6.
